(19) United States
(12) Patent Application Publication
(10) Pub. No.: US 2004/0240380 A1
(43) Pub. Date: Dec. 2, 2004

(54) Linear 1:1 channel APS signaling and switching method

(76) Inventors: Hsian Chao, Holmdel, NJ (US); David S. Einstein, Morganville, NJ (US); Yung-Ching Sha, Edison, NJ (US)

Correspondence Address: MOSER, PATTERSON & SHERIDAN, L.L.P., Attorneys at Law, Suite 100, 595 Shrewsbury Avenue, Shrewsbury, NJ, 07702, US

(21) Appl. No.: 10/448,730

(22) Filed: May 30, 2003

(51) Int. Cl. H04J 1/16; H04J 3/14

(52) U.S. Cl. 370/218; 370/539

(57) ABSTRACT

A switching algorithm, a signaling protocol, and a switching decision method having improved optical network switching features is described. In one embodiment, a local node, during a switch from the service channel to the protection channel, propagates a switching signal to a remote node before the local node has finished switching from the service channel to the protection channel. The remote node, in response to the received switching signal, begins switching from the service channel to the protection channel and transmits a signal back to the local node before the remote node has finished switching from the service channel to the protection channel.

### BACKGROUND OF THE INVENTION

1. Field of the Invention

The present invention relates generally to a network automatic protection switch (APS) in an optical fiber network, and more specifically to a switching algorithm, a signaling protocol, and a switching decision method for reducing the overall switching time in an optical fiber network.

2. Description of the Related Art

In a communications system requiring a very high uptime rate, a commonly used topography comprises redundant communications links (e.g., two physically distinct optical transmission links) to provide, thereby, a service channel and a protection channel. The service channel carries priority traffic and the protection channel carries actual traffic. In the event of a cut or other damage that disrupts priority traffic through the service channel, the same priority traffic may be retrieved from the protection channel. In this manner, priority traffic is not significantly interrupted and the actual traffic is dropped.

On the protect circuit, the K1 and K2 bytes from the channel overhead (LOH) of the SONET frame indicate the current status of the APS connection and convey any requests for action. This signaling channel is used by the two ends of the connection to maintain synchronization and to initiate switches, by the two ends (nodes), between the service channel and the protection channel.

In SONET 1+1 and 1:N (N=1,14) architectures, the APS protocol uses a handshake algorithm for the signaling between the two ends. This algorithm is quite complex because it has to cover 16 different configurations.

In addition, other factors also affect the switching time from the service channel to the protection channel. For example, the greater the distance between the two ends, the longer it takes switching instruction to travel the distance between the two nodes.

### SUMMARY OF THE INVENTION

These and other deficiencies of the prior art are addressed by the present invention of a switching algorithm, a signaling protocol, and a switch decision method. In one embodiment, a local node, during a switch from the service channel to the protection channel, propagates a switching signal to a remote node before the local node has finished switching from the service channel to the protection channel. The remote node, in response to the received switching signal, begins switching from the service channel to the protection channel and transmits a signal back to the local node before the remote node has finished switching from the service channel to the protection channel.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a high-level block diagram of a communications system utilizing the teachings of the present invention;

FIG. 2 depicts a prior art switching method; and

FIG. 3 depicts an embodiment of a switching method in accordance with the invention.

To facilitate understanding, identical reference numerals have been used, wherever possible, to designate identical elements that are common to the figures.

### DETAILED DESCRIPTION OF THE PREFERRED EMBODIMENT

A switching algorithm, a signaling protocol, and a switching decision method having improved optical network switching features is described. In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

For illustrative purposes only, the invention is described with respect to automatic protection switching in a 1:1 optical fiber network, however, that depiction is not intended in any way to limit the scope of the invention. For example, an aspect of the invention directed towards an embodiment of a switching decision method may be used in a 1+1 optical fiber network. An example of a 1+1 optical fiber network capable of being used with the invention is described in commonly assigned U.S. patent application Ser. No. 09/456,806 filed Nov. 29, 1999, (entitled “AUTOMATIC PROTECTION SWITCH DECISION ENGINE”) which is incorporated by reference herein. It is further noted that the invention can be adapted to work in mesh networks.

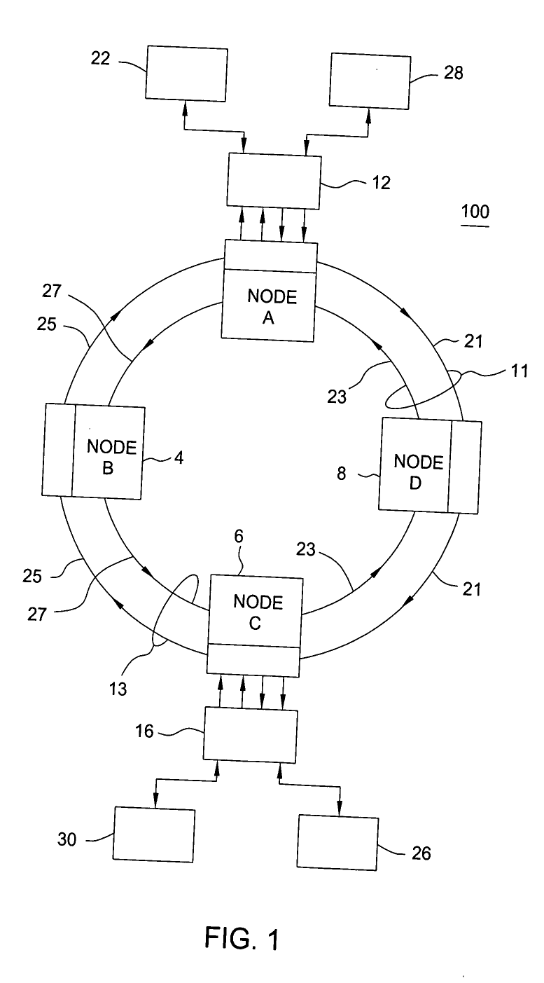

FIG. 1 depicts a high-level block diagram of an embodiment of a four-node bi-directional physical ring network 100, in accordance with the invention. Although the invention is described herein with respect to a ring network configuration, it is noted that, in other embodiments, the invention can be performed in a mesh network configuration. The ring network 100 comprises node A 2, node B 4, node C 6, and node D 8. Each of the nodes 2, 4, 6, and 8 is interconnected in the ring network 100 via a ring transmission line 11 and ring transmission line 13, respectively. Nodes 2 and 6 are connected to a respective network fabric 12 and 16.

A priority client 22 and actual client 28 are interconnected to node 2 via switch fabric 12. A priority client 26 and an actual client 30 are interconnected to node 6 via switch fabric 16. Nodes 2, 4, 6, and 8 form a physical ring connection, however priority traffic and actual traffic transmitted between nodes 2 and 6 are bypassed by nodes 4 and 8. Specifically, in the ring network 100, nodes 2 and 6 are considered logically linear and nodes 4 and 8 are ignored (interpreted logically as lines 11 and 13, respectively, and not being between nodes 2 and 6).

The configuration of the ring transmission line 11 is drawn here in further detail. That is, the ring transmission line 11 contains two optical fibers 21 and 23. Fibers 21 and 23 are in the service channel and allow the bi-directional communication of priority traffic between Node A 2 and Node C 6. Fibers 25 and 26 are in the protection channel and typically carry actual traffic between Node A2 and Node C 6. When necessary (e.g., due to an LOS or signal degradation) priority traffic is switched from the service channel to the protection channel. As a result of the switch of the priority traffic to the protection channel, the actual traffic is “bumped” from the protection channel. The optical fibers 21, 23, 25, and 27 are depicted to indicate the direction upon which they respectively propagate traffic.

For example, during normal operation, i.e., the priority traffic, from priority client 22, is transmitted between Node A 2 and Node C 6, to priority client 26, via the service channel (through physical Node D 8). Actual clients 22 and 30 communicate with each other via the protection channel 13 (through physical Node B 4). The actual clients 22 and 30 have lower QOS agreements with a provider. When an unacceptable quality of signal (QOS) (e.g., a LOS or a degradation in signal) is detected on the service channel 11, the switch fabric 12 and the switch 16 causes the priority traffic to switch to the protection channel 13. As a result of the switch to the protection channel 13, traffic by the actual clients 28 and 30 is “dropped” from the priority channel 13.

Examples of transmission failures that cause a switch to initiate a re-routing of traffic include, but are not limited to, a loss of signal (LOS), a loss of frame (LOF), an alarm indication signal (AIS-L). The terms LOS, LOF, and AIS-L are understood in the art and for brevity are not further defined herein. In addition, these terms are referred to as “hard events” which induce a switch to seek an alternate transmission pathway.

There are other instances when it becomes beneficial for a switch to find an alternate transmission pathway. For example, a switch (e.g., switch 12) monitors the bit error rate (BER) between its connected priority client 22 and a desired priority client (e.g., priority client 26) connected to the network 100 via switch 16.

The BER is the percentage of bits that have errors relative to the total number of bits received in a transmission, usually expressed as ten to a negative power. For example, in a transmission having a BER of 10-6, one bit out of 1,000,000 bits transmitted is in error.

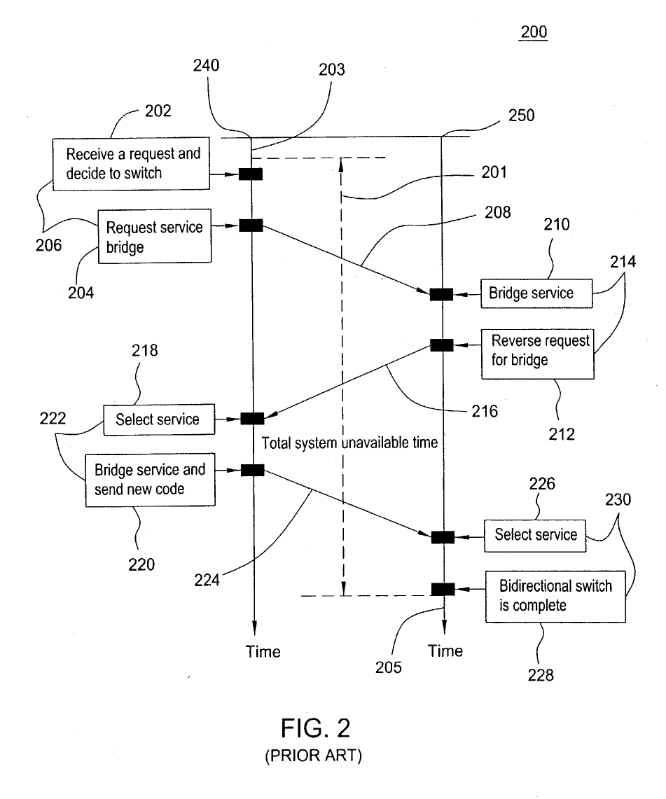

For illustrative purposes, presume that there is a LOS between nodes 2 and 6. As a result, node 2 (referred to hereafter as “near end 240”) is unable to propagate messages on the service channel, towards node 6 (referred to hereinafter as a “far end 250”). FIG. 2 depicts a prior art switching method 200 that switches the transmission of priority traffic from the service channel to the protection channel.

The method 200 comprises four system processes 206, 214, 222, and 230; and three message propagations 208, 216, and 224. Each system process 206, 214, 222, and 230 contains multiple sub-processes.

The near end 240 propagates traffic towards a far end 250 via a service channel. At time to, the near end 240 receives a request signal 203 to switch, indicative of an LOS or significant degradation of signal at the near end 240. In response thereto, the near end 240 initiates a system process 206.

System process 206 is initiated by the near end 240 after conditions are detected (e.g., an LOS or signal degradation) which cause the near end 240 to receive a request signal 203 to switch from the service channel to the protection channel. System process 206 comprises sub-processes 202 and 204. At sub-process 204, the near end 240 propagates a message 208 towards the far end 250 requesting that the far end 250 bridge its priority traffic from the service channel to the protection channel.

In response to the received message propagation 208, the far end 250 initiates system process 214. The system process 214 comprises sub-processes 210 and 212. At sub-process 210, the system processes the request to bridge. At sub-process 212, the system propagates a message 216 requesting that the near end 240 bridge priority traffic from the service channel to the protection channel.

In response to the message propagation 216, near end 240 initiates a system process 222. System process 222 comprises sub-processes 218 and 220. Upon receipt of the message propagation 216, system process 222 initiates sub-process 218. At sub-process 218, the near end 240 initiates a switch, at the near end 240, from the service channel to the protection channel. At sub-process 220, the near end 240 has switched from the service channel to the protection channel and propagates a message 224 towards far end 250.

In response to the message propagation 224, the far end 250 initiates a system process 230. The system process 230 comprises sub-processes 226 and 228. At sub-process 226 the far end 250 acknowledges receipt of the message propagation 224 indicating that the near end 240 has switched from the service channel to the protection channel. Further, at sub-process 226, the far end 250 initiates a switch, at the far end 250, from the service channel to the protection channel. At sub-process 228 of system process 230, the bi-directional switch is complete.

In FIG. 2, the total time 201 between to and to indicates the time that the system is unavailable. It is noted that the method 200 depicted in FIG. 2 contains four system processes and that each of the three respective message propagations is transmitted after a system process is complete. As a result, the total time of each system process and each message propagation is added to the switching time from the service channel to the protection channel. In addition, the method 200 uses the SONET APS protocol. The SONET APS protocol uses the K1 and K2 bytes to transmit switching information. A further limitation inherent in method 200 is the handshaking between the near end 240 and far end 250 that sends and acknowledges the K1 and K2 line overhead (LOH) bytes between the two ends.

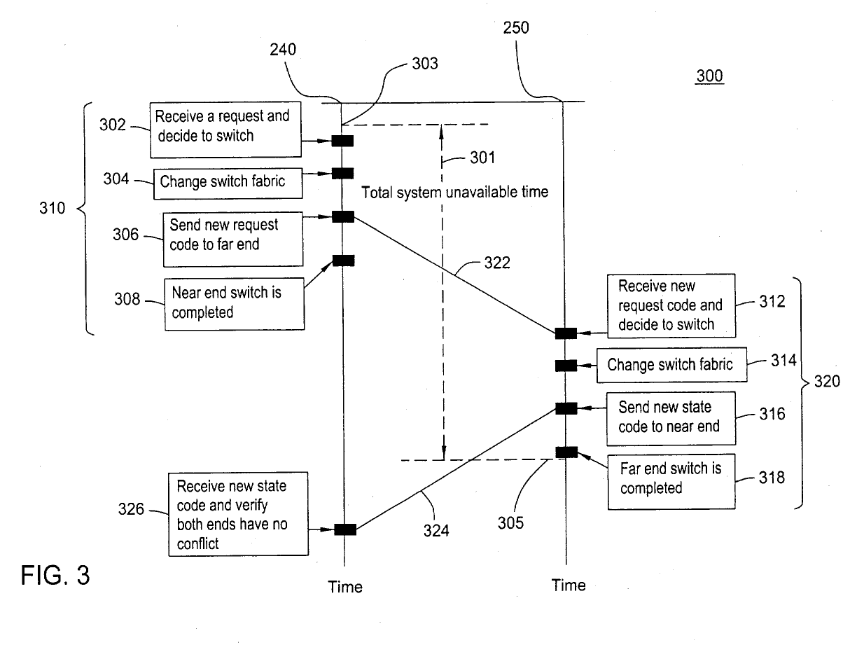

FIG. 3 depicts an embodiment of a switching method 300 in accordance with the invention. FIG. 3 depicts a method 300 that uses fewer systems processes and message propagations than the SONET switching method 200 depicted in FIG. 2. In addition, method 300 utilizes other features which reduce the switching time from the service channel to the protection channel. For example, system processes of the method 300 do not wait until the respective system process has completed all of its respective sub-processes before it sends a message propagation.

The method 300 comprises three system processes 310, 320, and 326; and two message propagations 322 and 324. Each system process 310, 320, and 326 contains multiple sub-processes.

The near end 240 and the far end 250 propagate traffic towards each other via a service channel-switching message on the protection channel. In FIG. 3, at time to, the near end 240 receives a request signal 303 to switch, indicative of an LOS or significant degradation of signal at the near end 240. In response thereto, the near end 240 initiates a system process 310.

System process 310 comprises sub-processes 302, 304, 306, and 308. At time to, the near end 240 receives a request 303 to switch, from the service channel to the protection channel. In response to that request, the near end 240 decides to switch from the service channel to the protected channel.

At sub-process 304, the near end 240 initiates a switch from the service channel to the protection channel. In addition, sub-process 306 sends code (located in one byte and described in greater detail below) towards the far end 250 indicating that the near end 240 has initiated a switch from the service channel to the protection channel. The code is propagated towards the far end 250 via message 322. After the near end 240 propagates message 322, the near end 240 completes its switch from the service channel to the protection channel.

After the far end 250 receives the message 322, the far end 250 initiates system process 320. System process 320 comprises sub-processes 312, 314, 316, and 318.

In sub-process 312, the far end 250 receives the code within message 322, indicative of the near end 240 switch, and decides to switch from the service channel to the protected channel. System process 320 proceeds to sub-process 314.

In sub-process 314, the far end initiates a switch from the service channel to the protection channel. The system process 320 proceeds to sub-process 316.

In sub-process 316, the far end 250 propagates a message 324 towards the near end 240. The message 324 contains code within one byte indicating that the far end 250 is switching from the service channel to the protection channel. The system process 250 proceeds to sub-process 318.

In sub-process 318, the far end 250 has completed the switch from the service channel to the protection channel, during the propagation of message 324 from the far end 250 towards the near end 240.

In method 300, the total time that it takes (from to t₀ t₁) to switch from the service channel to the protection channel is indicated by lead line 301. Note that both nodes transmit priority traffic at t₁ on the protection channel. In addition, note that depending upon the distance between the near end 240 and the far end 250, t₁ occurs before the near end 240 has received propagation message 324.

As indicated above, the near end 240 and the far end 250 propagate a one byte code to one another, in the protection channel, to initiate and switch the transmission of priority traffic on the protection channel. Each of the nodes uses a protocol developed for transmission, within one byte, of the necessary switching instructions. Table 1 provides the instructions contained within bits 1 thorough 4, while Table 2 provides the instructions contained within bits 5 through 8.

Table 1 contains three columns. The first column contains coding instructions for each of the first four bits. Bits 1 through 4 of the APS signaling byte are used to indicate a request that may be either a signal condition or an APS command. The instructions contained within a sequence of bit code are assigned a priority with respect to the other instructions contained within other sequences of bit code.

The second column contains the priority of the instructions with respect to the other instructions. Only an instruction having the highest priority is sent to the far end 250.

The third column contains the instruction assigned to the bit series in column one. For example, the “lockout of protection” instruction has the highest priority and is assigned the sequence “1111”.

Table 1 also includes several sequences of bits reserved for future association with instructions and priority. For example, bit series “0101” has not been assigned an instruction or a priority. The series of bits that have not been assigned instructions or a priority will not be transmitted from one end to another end.

TABLE 1
APS signaling request codes.

| | | Request (Signal condition or |
|---|---|---|
| Bit 1, 2, 3, 4 | Priority | APS command) |
| 1111 | 1 | Lockout of protection |
| 1110 | 2 | SF in protection |
| 1101 | 3 | Forced switch to non-bridge |
| 1100 | 4 | Forced switch to bridge |
| 1011 | 5 | SF in service |
| 1010 | 6 | SD in protection |
| 1001 | 7 | SD in service |
| 1000 | 8 | Manual switch to non-bridge |
| 0111 | 9 | Manual switch to bridge |
| 0110 | | (Not used, reserved for future extension) |
| 0101 | | (Not used, reserved for future extension) |
| 0100 | | (Not used, reserved for future extension) |
| 0011 | | (Not used, reserved for future extension) |
| 0010 | | (Not used, reserved for future extension) |
| 0001 | NA** | Clear** |
| 0000 | 10 | No request |

Once a local request is accepted, the accepting end transmits a new request code to another end within 10 ms. For example, when near end 240 propagates message 322 towards far end 250, far end 250 will propagate a message 324 containing new code towards near end 240. The new code propagated by either end shall contain applicable instructions containing the highest priority. It is noted that the new code may or may not initiate a switch to the protection channel.

The instruction code “0001” is associated with the command “Clear.” The command “Clear” clears the other APS instruction commands in Table 1. For example, the near end 240 transmits instruction code “0001” for a duration of one second, towards the far end 250. Upon receipt of the “0001” code, the far end 250 will clear the APS commands in its memory. However, if the far end 250 detects that a condition exits (e.g., an LOS) then the far end will transmit code-containing bits indicative of the LOS.

Table 2 contains instructions transmitted in bits 5 through 8 of the one-byte switching code. Specifically, Table 2 contains two columns. The first column contains the bit number. The second column contains an instruction associated with the bit. For example, the near end 240 and the far end 250 each send, in bit 5, a test signal every second to the other end. Within 10 ms of receipt of the test signal, the near end 240 and the far end 250 each send an acknowledgement signal in bit 6 to the other end.

Bit 7 is used to indicate whether an end (e.g., the near end 240) is going to remain in a non-bridge state (i.e., continue transmitting priority traffic on the service channel) or change fabric to a bridge state (i.e., switch from the service channel to the protection channel). Once the state of switch fabric is changed, the new code shall be sent to far end within 10 ms.

Bit 8 is used as a channel indicator. This bit is used to insure that the polarity of the switch fabrics are correct. For example, in bit 8 “0” indicates a connection to the service channel while a “1” indicates a connection to the protection channel. If “0” is received, in bit 8, by a switch fabric when there should be a “1” then an alarm signal is generated indicative of an improper connection.

TABLE 2
Codes for bits 5 through 8 of APS signaling byte.

| | Function and note |
|---|---|
| Bit 5 | Test. |
| | This bit is used to send one bit test pattern to far end. |
| Bit 6 | Acknowledge. |
| | This bit is used to return the far end test pattern back to far end. |
| Bit 7 | Switch fabric state. |
| | This bit is used to inform far end the local switch fabric state. |
| | 0 = Non-bridge, 1 = Bridge. |
| Bit 8 | Channel indication. |
| | This bit is used to tell far end what channel is this channel. |
| | 0 = Service channel, 1 = Protection channel. |

For the instructions contained in bits 1-8, a new code on the received APS signaling byte shall replace the current received code if it is received identically in three consecutive frames.

Table 3 depicts an APS database that keeps track of the transmission of the message propagations by both the near end 240 and far end 250. Illustratively, the database has two 10-bit flags. One of the flags is service channel flag and the other is a protection channel flag. Each of the flags is depicted in Table 3 below. Each bit in these flags can be set to zero or one. The service channel flag and protection channel flag are juxtaposed to illustrate a relationship between the two flags. For example, bits 1, 3, 5, and 6 of the service channel flag are allocated to carry instructions, however, in the protection channel flag these bits are not allocated to carry instructions. Also, bits 2, 4, 7, 8, and 9 of the protection channel flag are allocated to carry instructions while in the service channel flag these bits do not carry instructions. For example, in Table 3, in the service channel flag, bit 5 contains “SSF” indicative of signal failure in the service channel.

Those bits allocated for instructions contain abbreviations of their respective instructions. The abbreviations and their instructions are as follows:

MSB: Manual switch to bridge;

MSN: Manual switch to non-bridge;

SSD: SD in service;

PSD: SD in protection;

SSF: SF in service;

FSB: Forced switch to bridge;

FSN: Forced switch to non-bridge;

PSF: SF in protection; and

LO: Lockout.

TABLE 3
Service channel flag:

| Bit 9 | 8 | 7 | 6 | 5 | 4 | 3 | 2 | 1 | Bit 0 |
|---|---|---|---|---|---|---|---|---|---|
| 0 | 0 | 0 | FSB | SSF | 0 | SSD | 0 | MSB | 0 |

Protection channel flag:

| Bit 9 | 8 | 7 | 6 | 5 | 4 | 3 | 2 | 1 | Bit 0 |
|---|---|---|---|---|---|---|---|---|---|
| LO | PSF | FSN | 0 | 0 | PSD | 0 | MSN | 0 | 1 |

Note that bit 0 of protection channel flag is one and all other unassigned bits are zero. In addition, those bits allocated for instructions may contain a zero or a one. Table 4 illustrates the effect that a zero or a one in one instruction has on another instruction. Table 4 comprises two columns. The first column provides the instruction. The second column provides the effect on the selection of a particular instruction on the other instructions.

TABLE 4
Bits setup of flags.

| Request | Bits setup |
|---|---|
| Manual switch to bridge | MSB = 1 |
| Manual switch to non-bridge | MSN = 1, MSB = 0 |
| SD in service | SSD = 1, MSN = MSB = 0 |
| SD in protection | PSD = 1, MSN = MSB = 0 |
| SF in service | SSF = 1, MSN = MSB = 0 |
| Forced switch to bridge | FSB = 1, MSN = MSB = 0 |
| Forced switch to non-bridge | FSN = 1, FSB = MSN = MSB = 0 |
| SF in protection | PSF = 1, FSN = FSB = MSN = MSB = 0 |
| Lockout | LO = 1, FSN = FSB = MSN = MSB = 0 |
| Clear | LO = FSN = FSB = MSN = MSB = 0 |
| SD cleared in service | SSD = 0 |
| SD cleared in protection | PSD = 0 |
| SF cleared in service | SSF = 0 |
| SF cleared in protection | PSF = 0 |

The switch decision method is performed in accordance with the following set code:

```
If (service channel flag > protection channel flag)
{
    Switch to bridge if the current state of switch fabric is non-bridge.
}
If (protection channel flag > service channel flag)
{
    Switch to non-bridge if the current state of switch fabric is bridge.
}
```

While the foregoing is directed to embodiments of the present invention, other and further embodiments of the invention may be devised without departing from the basic scope thereof, and the scope thereof is determined by the claims that follow.

1. A method, comprising:
initiating an alteration of a near end switching fabric;
transmitting a message indicative of said initiation towards a far end switching fabric prior to completion of said near end switching fabric alteration; and
receiving a message from said far end switching fabric indicative of the initiation of an alteration of said far end switching fabric, said near end and far end switching fabrics effecting a new communications path upon completion of said alteration.

2. The method of claim 1, wherein said received message is transmitted prior to completion of said alteration of said far end switching fabric.

3. The method of claim 1, wherein said messages comprise one overhead byte communicated between said near end and said far end switching fabrics via a protection channel.

4. The method of claim 1, further comprising:
updating a state code associated with said far end switching fabric in response to said received message.

5. The method of claim 4, wherein said state code indicates at least one of a lock-out of protection parameter, a signal failure protection parameter, a forced switch to a non-bridge parameter, a forced switch to a bridge parameter, a signal failure in a service channel parameter, a signal degradation and protection channel parameter, a signal degradation and a service channel parameter, a manual switch to a non-bridge parameter, and a manual switch to a bridge parameter.

6. The method of claim 1, further comprising:
resetting said near end switching fabric in response to a received message indicative of said far end switching fabric not completing its respective alteration.

7. A method for use in a communication network, said network routing traffic from a first communication path to a second communication path wherein said routing comprises:
receiving a first one byte overhead signal and altering a near switching fabric in response to said first signal;
transmitting a second one byte overhead signal from said near end switching fabric to a far end switching fabric; and
altering said far end switching fabric in response to said second signal.

8. The method according to claim 7, further comprising:
resetting said communication network when said near end switching fabric does not contain the same switching information as said far end switching fabric.

9. An automatic protection switch signaling system comprising:
a near end switching fabric responsive adapted to communicate with a far end switching fabric to establish at least one communications channel there-between;
said near end switching fabric, in response to a fabric alteration command, initiating a near end switch to a protection channel;
said near end switching fabric propagating towards a far end switching fabric via said protection channel a message indicative of said initiation of said near end switch fabric alteration; and
receiving a message from said far end switching fabric indicative of the initiation of an alteration of said far end switching fabric.

10. The system according to claim 9, further comprising:
a detector, for determining whether said near end switching fabric corresponds with said far end switching fabric; and
an alarm, for sending a reset signal when said near end switching fabric does not correspond with said far end switching fabric.

11. A network architecture, comprising:
a plurality of network elements, comprising a near end switching fabric and a far end switching fabric;
said near end switching fabric being responsive to indication of an unacceptable BER to initiate alteration of said near end switching fabric and propagate a message towards said far end switching fabric indicative of said alteration initiation, said far end switching fabric being responsive to said message from said near end switching fabric of said far end switching fabric and propagate a message towards said near end switching fabric indicative of a state of said far end switching fabric.
